(19) United States
(12) Patent Application Publication
(10) Pub. No.: US 2021/0385352 A1
(43) Pub. Date: Dec. 9, 2021

(54) IMAGE READING DEVICE AND IMAGE READING METHOD

(71) Applicant: TOSHIBA TEC KABUSHIKI KAISHA, Tokyo (JP)

(72) Inventor: Tetsuya SADOWARA, Mishima Shizuoka (JP)

(21) Appl. No.: 17/190,221

(22) Filed: Mar. 2, 2021

(30) Foreign Application Priority Data
Jun. 8, 2020 (JP) 2020-099666

(51) Int. Cl. H04N 1/387; H04N 1/00; G06K 9/32

(52) U.S. Cl. CPC H04N 1/3877; H04N 1/00456; G06K 2209/01; H04N 1/00331; G06K 9/3208; H04N 1/00411

(57) ABSTRACT

According to one embodiment, an image reading device includes a scanner and a controller. The scanner can read multiple documents placed together on a document platen and generate image data accordingly. The controller generates individual document image data by cropping a region corresponding to each document on the document platen from the generated image data. When a multi-sided scanning mode or option is selected, the controller associates generated document image data for a front surface of each document with generated document image data for a back surface of the same document to establish a document image data pair for each individual document. When a rotation instruction is received for one piece of document image data in a document image pair, the controller rotates both pieces of document image data in the document image pair together. The rotated document image data pair can then be output together.

### CROSS-REFERENCE TO RELATED APPLICATION

This application is based upon and claims the benefit of priority from Japanese Patent Application No. 2020-099666, filed on Jun. 8, 2020, the entire contents of which are incorporated herein by reference.

### FIELD

Embodiments described herein relate generally to an image reading device and an image reading method.

### BACKGROUND

Some image reading devices have a function, which may be referred to as a multi-cropping process, by which images for multiple documents scanned at the same time can be cut out (separated) from each other. If the multi-cropping process is instructed during a scanning process, the image reading device separates out image data of each original document to generate the image data. If a scanning process on both sides of the same sheets/documents is further instructed, the image reading device can generate pieces of image data for each side of the sheets/documents, in accordance with the multi-cropping process.

When the image reading device generates multiple pieces of image data by such processes, there is a problem that the related processes of, for example, adjusting the direction/orientation of each piece of image data becomes more complicated.

### BRIEF DESCRIPTION OF THE DRAWINGS

FIG. 1 is an external view illustrating an example of an overall configuration of an image forming apparatus according to an embodiment.

FIG. 2 is a block diagram illustrating an example of a hardware configuration of an image reading device in an embodiment.

FIG. 3 is a schematic block diagram illustrating a functional configuration of an image control program in an embodiment;

FIG. 4 is a flowchart illustrating a process of reading an original document in the embodiment.

FIG. 5 is a diagram illustrating an example disposition state of original documents on a document placing table when a scanning process of a front surface is performed.

FIG. 6 is a diagram illustrating an example disposition state of original documents on a document placing table when the scanning process of a back surface is performed.

FIG. 7 is a diagram illustrating a first example of a preview screen for image data displayed by a control panel.

FIG. 8 is a diagram illustrating a first example of a rotation control screen displayed by a control panel.

FIG. 9 is a diagram illustrating a second example of a rotation control screen.

FIG. 10 is a diagram illustrating a second example of a preview screen for image data.

### DETAILED DESCRIPTION

An object to be achieved by an exemplary embodiment is to provide an image reading device and an image reading method reducing the complexity of the process of adjusting the direction of each piece of image data when a multi-cropping process is performed on both sides of an original document.

In general, according to one embodiment, an image reading device includes a scanner configured to read multiple documents on a document platen and generate image data therefrom. A controller is configured to generate document image data by cropping a region corresponding to each individual document on the document platen from the generated image data and, when multi-sided scanning is selected, associate generated document image data for a front surface of each document with generated document image data for a back surface of the same document to establish a document image data pair for each document on the document platen. The controller is further configured to receive a rotation instruction for one piece of document image data in a document image pair and then rotate both pieces of document image data in the document image pair together. The controller outputs the rotated document image data pair, for example as a single file including image data for both sides of the same document.

Hereinafter, an image reading device and an image reading method according to one or more embodiments will be described with reference to the drawings.

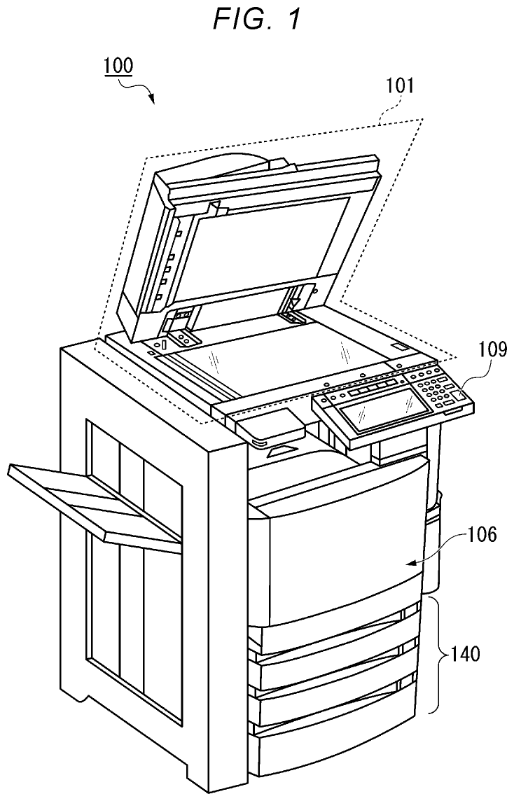

FIG. 1 is an external view illustrating an example of an overall configuration of an image processing apparatus 100 according to an embodiment. For example, the image processing apparatus 100 is a multi-functional peripheral (MFP) device. The image processing apparatus 100 includes an operation unit 109, a printer unit 106, a sheet storage unit 140, and a scanner unit 101. The printer unit 106 may be an electrophotographic apparatus that fixes a toner image or an inkjet apparatus.

The image processing apparatus 100 of the present non-limiting example forms an image on a sheet with a developer of a toner or the like. The sheet is paper or label paper, for example. As the sheet, in general, any object may be used so long as the image processing apparatus 100 is capable of forming an image on a surface of the object.

The operation unit 109 includes a control panel. The control panel includes an image display device such as a liquid crystal display and an organic electroluminescence (EL) display. The control panel displays various types of information regarding the image processing apparatus 100 to a user or operator. The control panel includes a plurality of buttons and receives an input operation from a user. The control panel may be configured as a touch panel display.

The printer unit 106 can form an image on a sheet based on image data generated by the scanner unit 101. The printer unit 106 can also form an image on a sheet based on image data received via a network or otherwise. The printer unit 106 of the present example forms an image by the following process.

The printer unit 106 forms an electrostatic latent image on a photosensitive drum based on image data. The printer unit 106 forms a visible image by adhering the developer of the toner to the electrostatic latent image on the photosensitive drum. As the toner, toners of colors such as yellow, magenta, cyan, and black can be used, for example.

The printer unit 106 transfers the visible (toner) image onto a sheet. The printer unit 106 fixes the visible image on the sheet by applying heat and pressure to the sheet. The printed sheet is then discharged to the outside of the apparatus by a sheet discharge unit.

The sheet storage unit 140 stores a sheet to be used when the printer unit 106 forms an image. A sheet may be a sheet fed from the sheet storage unit 140 or may be a manually-fed sheet.

The scanner unit 101 reads an image from a scanning target object (referred to as an original document) based on differences in reflected light from the original document or the like and performs conversion of the reflected light signal into image data of RGB values or the like. The scanner unit 101 thus records image data of the image read from the scanning target. The recorded image data may be transmitted to another information processing apparatus via a network. Also, the recorded image data may be printed on a sheet by the printer unit 106.

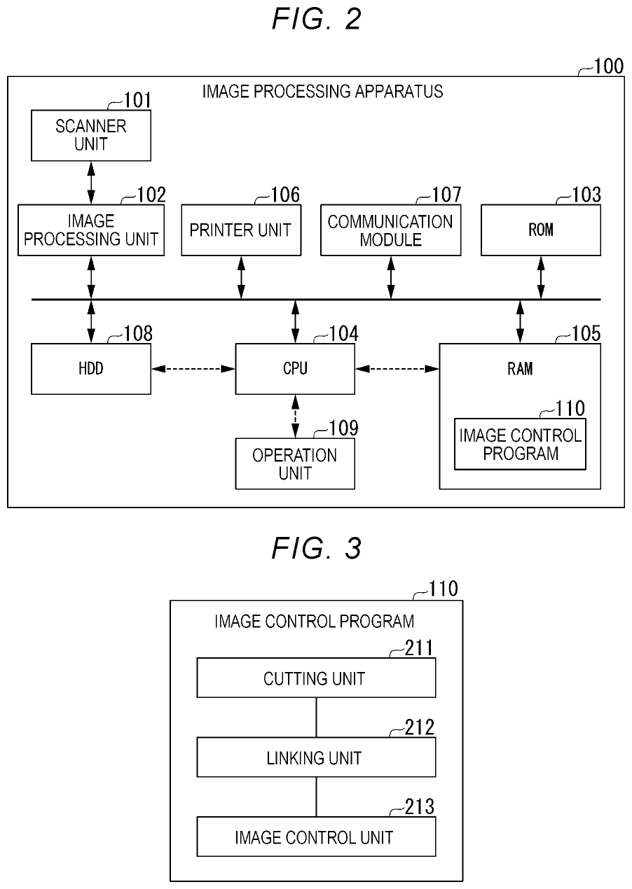

FIG. 2 is a diagram illustrating an example of a hardware configuration of the image processing apparatus 100 in the present embodiment. The image processing apparatus 100 includes the scanner unit 101, an image processing unit 102, a ROM 103, and a central processing unit (CPU) 104. The image processing apparatus 100 further includes a random access memory (RAM) 105, the printer unit 106, a communication module 107, a hard disk drive (HDD) 108, and the operation unit 109. The units are connected to each other via a bus.

The scanner unit 101 performs scanning of an original document disposed on the document placing table (document platen) to generate image data. The scanner unit 101 outputs the generated image data to the image processing unit 102. Although not separately illustrated, the scanner unit 101 includes a charge coupled device (CCD) sensor, a scanner lamp, a scanning optical system, a condenser lens, and the like.

The CCD sensor converts reflected image light into an electrical signal to generate image data. The scanner lamp supplies light for reflection from a reading target for acquiring an image. The scanning optical system is equipped with a mirror that changes an optical path of reflected light from the reading target (original document) as necessary for processing by the CCD sensor or the like. The condenser lens condenses the reflected light from the original document for forming an image.

The image processing unit 102 performs image processing based on image data output from the scanner unit 101. The image processing includes processing such as reversal, enlargement, reduction, and filtering of image data. The image processing unit 102 stores the image data, after the image processing, in the RAM 105, the HDD 108, or the like. The printer unit 106 forms an image on a sheet based on input image data, in response to a printing instruction (command).

The operation unit 109 includes the control panel as described above. The control panel receives designation(s) of setting information regarding the scanning process, a printing process and/or a start instruction, in accordance with an input operation of the user. The operation unit 109 controls the display of the control panel and acquires information input by the user through the control panel.

The CPU 104 controls the overall operation of the image processing apparatus 100. The CPU 104 reads and executes an image control program 110 stored in the RAM 105 or otherwise. The RAM 105 and the HDD 108 store image data received from the outside through the communication module 107. The ROM 103 stores data and the like used in processes by the various units of the image processing apparatus 100.

FIG. 3 is a schematic block diagram illustrating a functional configuration realized by the image control program 110. In general, the CPU 104 executes the image control program. 110 stored in the RAM 105 or the like to realize functions which are described in the following for a cutting unit 211, a linking unit 212, an image control unit 213, and the like. Some of these functions may be realized by a dedicated electronic circuit or the like. In the present embodiment, the combination of the scanner unit 101 and the functional units 211 to 213 realized by execution of the image control program 110 is also referred to as an image reading device.

The cutting unit 211 performs a multi-cropping process on image data generated by the scanner unit 101. The multi-cropping process is a process of cutting out or delineating an image of each of the original documents if a plurality of original documents is disposed on the document placing table and scanned together in one scanning operation (e.g., scanning is performed once). In the present embodiment, the original documents can be, for example, a business card, a receipt, and/or a certificate. If the multi-cropping process is instructed, the cutting unit 211 cuts out regions corresponding to each original document from the image data generated by the scanner unit 101. This cutting out of different regions generates a plurality of pieces of image data. The cutting unit 211 stores the plurality of pieces of generated image data in the RAM 105 or the like.

If a double-sided scanning process on one or more of the original documents is performed, the linking unit 212 associates image data of the front surface to image data of the back surface of the same original document, as an image data pair. The linking unit 212 detects image data from the front surface and the back surface of the same original document based on coordinate information of each piece of the image data, for example.

The image control unit 213 performs any rotation control necessary for each image data pair that has been associated by the linking unit 212. The image control unit 213 rotates the direction of the image data pair in accordance with a rotation instruction input through the operation unit 109 or the like. The rotation instruction includes identification information of image data as a rotation target, and the direction and the degree of rotation. In some examples, either or both the direction and the degree of rotation may be predetermined or preset. In this case, the rotation instruction may include at least identification information of image data as the rotation target. The image control unit 213 stores the image data after the rotation control, in the RAM 105 or the like.

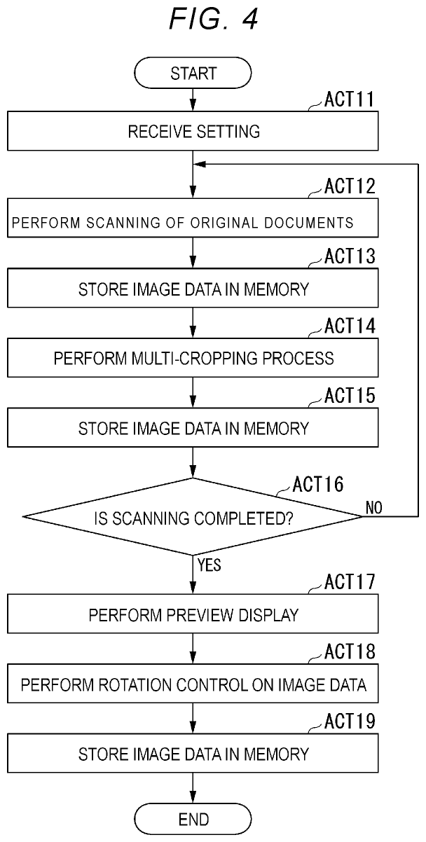

FIG. 4 is a flowchart illustrating a process of scanning original documents in the embodiment. The operation unit 109 receives an instruction of setting for a scanning process, through the control panel (ACT11). For example, the operation unit 109 receives a user selection for color or monochrome, a setting indicting whether or not double-sided scanning is requested, and setting of whether or not the multi-cropping process is requested.

For example, a user selects buttons of “double-sided scanning process” and “multi-cropping process” from a menu displayed at the control panel to instruct particular settings. The operation unit 109 notifies the image control unit 213 of setting information input through the control panel. In some examples, an external device connected to the image processing apparatus 100 through the communication module 107 may provide the setting information regarding the scanning process to the image control unit 213.

If the multi-cropping process is instructed, a plurality of original documents can be placed on the document placing table of the scanner unit 101. After a start of the scanning process is instructed in this state, the scanner unit 101 reads the original documents disposed on the document placing table and generates image data (ACT12). The scanner unit 101 stores the generated image data in the RAM 105 (ACT13).

The cutting unit 211 then performs the multi-cropping process based on the image data stored in the RAM 105 (ACT14). The cutting unit 211 detects a region for each of a plurality of original document images in the image data and generates image data corresponding to the detected regions for each original document.

Specifically, the cutting unit 211 analyzes the value of each pixel in the image data and extracts edge information of the original document images in the image data. The cutting unit 211 next detects coordinate information indicating four vertices (corners) for defining a region for each original document image and also the size of the region based on the extracted edge information of the original document image. The cutting unit 211 generates image data of each original document image based on the coordinate information and the size of the original document image, which have been detected.

At this time, the cutting unit 211 may change the orientation of the cut-out image data based on the content of each original document image. For example, the cutting unit 211 cam detect a character string in an image region by performing an optical character recognition (OCR) process on image data. The cutting unit 211 may then rotate the image data based on a writing direction of the detected character string. For example, the cutting unit 211 rotates the image data such that the arrangement direction of the character string coincides with a left-right direction.

The cutting unit 211 stores the image data of each of the plurality of original documents, which is generated by the multi-cropping process, in the RAM 105 (ACT15). The cutting unit 211 may further store coordinate information of each piece of image data in association with the image data.

The image control unit 213 determines whether or not the scanning process is completed (ACT16). If a “double-sided scanning process” was set in ACT11, the image control unit 213 determines whether or not the scanning process on both sides of the original document has been completed.

If the scanning process is not completed (NO in ACT16), the image control unit 213 returns to ACT12. In this case, for example, the image control unit 213 also outputs information to the control panel for urging the user to reverse (flip over) the original documents disposed on the document placing table. The user reverses the original documents on the document placing table in accordance with the displayed information and then instructs the start of the scanning process once the documents have been reversed (flipped). The image control unit 213 then performs the processes of ACT12 to ACT15 for the back surfaces of each original document.

Here, a possible disposition state of the original documents on the document placing table when the scanning process is performed will be schematically described as one example.

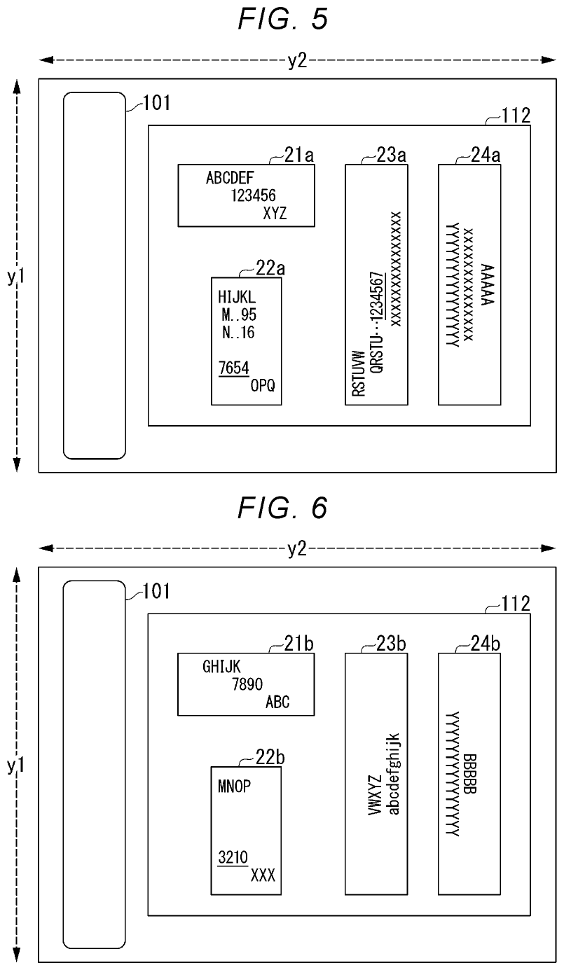

FIG. 5 is a diagram illustrating the disposition state of the original document on the document placing table when the scanning process is performed on the front surfaces of the original documents.

FIG. 6 is a diagram illustrating the disposition state when the scanning process is performed on the back surfaces of the original documents. That is, FIG. 5 represents the state of the original documents for the initial (front side) scanning process, and FIG. 6 represents the state of the same original documents after being flipped over of the second (back side) scanning process. In FIGS. 5 and 6, the direction y1 indicates a main scanning direction of the scanner unit 101, and the direction y2 indicates a sub-scanning direction. FIGS. 5 and 6 illustrate original document images when viewed from the lower side of a document placing table 112 toward a document disposition surface and illustrate the original document images on a reading target surface. That is, these figures are the view of the documents from the viewpoint looking up through the document platen such as the reading unit itself would see during scanning operations.

In FIG. 5, four original documents 21a to 24a are disposed on the document placing table 112. Character strings are spelled on the original documents 21a and 22a in the sub-scanning direction y2. Character strings are spelled on the original documents 23a and 24a in the main scanning direction y1. The character strings on the original document 23a are spelled from the bottom to the top, and the character strings on the original document 24a are spelled from the top to the bottom.

The cutting unit 211 crops and generates image data of each of the original documents 21a to 24a based on the coordinate information and the size of each of the original documents 21a to 24a and stores the generated image data in the RAM 105. At this time, the cutting unit 211 changes the orientation of the image data for each document, for example, such that the arrangement direction of the character string in the image data of each of the original documents 21a to 24a coincides with the left-right direction. Then, the cutting unit 211 stores the image data with the changed orientation.

In FIG. 6, four original documents 21b to 24b are disposed on the document placing table 112. In this example, the original document 21b is the back surface of the original document 21a, the original document 22b is the back surface of the original document 22a. Similarly, the original document 23b is the back surface of the original document 23a, and the original document 24b is the back surface of the original document 24a. Character strings are spelled on the original documents 21b and 22b in the sub-scanning direction y2. Character strings are spelled on the original documents 23b and 24b in the main scanning direction y1. The character strings on the original document 23b are spelled from the bottom to the top, and the character strings on the original document 24b are spelled from the top to the bottom.

The cutting unit 211 crops and generates image data of each of the original documents 21b to 24b based on the coordinate information and the size of each of the original documents 21b to 24b and stores the generated image data in the RAM 105. At this time, the cutting unit 211 changes the orientation of the image data, for example, such that the arrangement direction of the character string in the image data of each of the original documents 21b to 24b coincides with the left-right direction. Then, the cutting unit 211 stores the image data with the changed orientation.

Referring back to the flowchart in FIG. 4, if the scanning process on both the sides is completed (YES in ACT16), the linking unit 212 links the image data of the front surface and the image data of the back surface of the same original document to each other. That is, the linking unit 212 associates the image data of the front surface and the image data of the back surface of the same original document with each other, as an image data pair.

Specifically, the linking unit 212 detects pieces of image data forming a pair (a front and a back of the same document sheet), based on the coordinate information of each piece of image data, which is detected by the cutting unit 211. The linking unit 212 calculates barycentric coordinates for each piece of image data based on the coordinate information of the four vertices. When the linking unit 212 calculates the barycentric coordinates, the linking unit 212 detects a pair of pieces of image data having positions of the barycentric coordinates, which are relatively close to each other, from an image data group of the front surface and an image data group of the back surface. The linking unit 212 performs the association by adding the same original document ID to the detected image data pair.

After the association by the linking unit 212, the image control unit 213 displays a preview image of image data of each of both sides (ACT17). The image control unit 213 displays the preview image, for example, based on the image data stored in the RAM 105. The image control unit 213 may display the image data stored in the RAM 105 or may reduce the resolution of the image data and then display the image data. The image control unit 213 performs the display such that the image data pair indicating pieces of image data of the front surface and the back surface of the same original document can be visually identified by the user.

When the preview screen is displayed, the image control unit 213 performs rotation control of image data (ACT18). The image control unit 213 receives a rotation instruction for image data by the user, in accordance with an input operation on the control panel. The image control unit 213 rotates the image data pair in accordance with the input instruction and generates image data after the rotation process. The image control unit 213 then stores the rotated image data in the RAM 105 (ACT19). In other examples, the image control unit 213 may transmit the rotated image data to an external device.

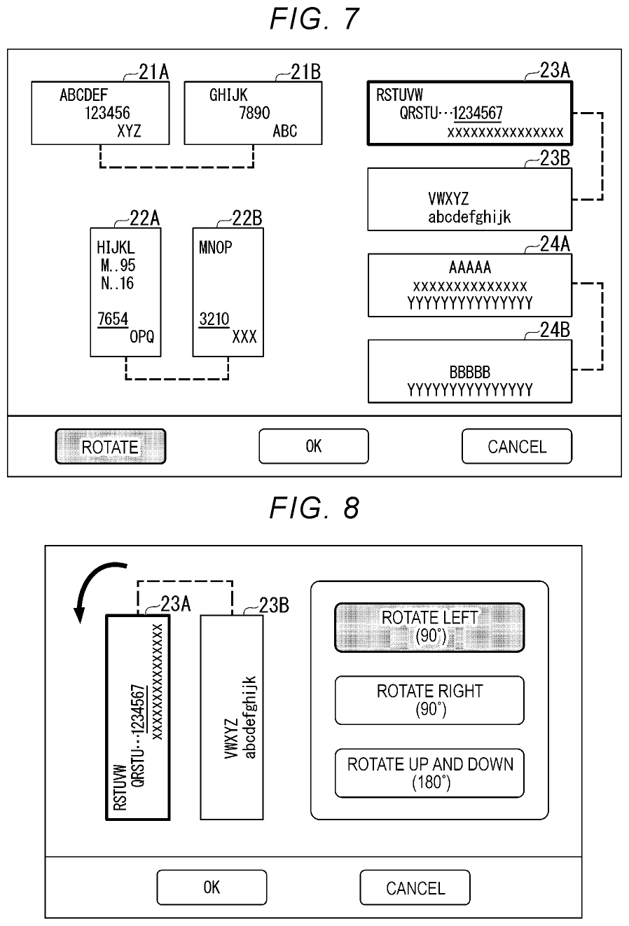

FIG. 7 is a diagram illustrating a first example of the preview screen of image data displayed by the control panel. The preview screen shows present associations (linkage) between different pieces of image data in accordance with a dotted line connecting different pairs of preview images such that each image data pair is made clear to the user. According to the example in FIG. 7, the preview screen shows image data 21A and image data 21B are an image pair. Similarly, the preview screen shows image data 22A and 22B are a pair image data 23A and 23B are a pair, and image data 24A and 24B are a pair.

As described above, the cutting unit 211 analyzes, for example, the direction and the like of the character strings in the image data by an OCR process or the like and adjusts the direction of the image data in accordance with the detected direction of the character strings. Thus, the arrangement direction of the character strings in each piece of the image data 21A to 24A and 21B to 24B illustrated in FIG. 7 coincides with the left-right direction. As described above, the direction of the image data may be automatically changed to a direction in which the character string is most easily read. The direction of the image data may be automatically changed by text skew correction process, for example. In other examples, the direction of the image data may be automatically changed according to the shape or the size of the image data.

The user selects, for example, the image data 23A indicated by a thick frame from the preview image as illustrated in FIG. 7 and then presses a “rotate” instruction button on the control panel. If the image control unit 213 detects the pressing of the “rotation” instruction button, the image control unit 213 causes a rotation control screen illustrated in FIG. 8 to be displayed at the control panel.

FIG. 8 is a diagram illustrating a first example of the rotation control screen displayed at the control panel. The rotation control screen illustrated in FIG. 8 includes three buttons for instructing the direction and the degree of rotation. The three buttons are buttons for instructing “rotate right (90°)”, “rotate left (90°)”, and “rotate up and down (180°)”. The rotation instruction(s) is not limited to the example in FIG. 8. For example, the rotation control screen may further include buttons for instructing “rotate right (15°)”, “rotate right (30°)”, and “rotate right (45°)”. The image control unit 213 may receive the instruction of the direction and the degree of rotation through a ten-key pad or the like on the control panel. Either of the direction and the degree of rotation may be preset.

The image control unit 213 displays the image data 23B (that forms a pair with the image data 23A) in a preview manner, in addition to the selected image data 23A. In the example in FIG. 8, a case where the user presses the button for instructing “rotate left (90°)” is described as an example. In response to the detection of button pressing, as illustrated in FIG. 8, the image control unit 213 displays, in a preview manner, an image obtained by rotating the direction of the image data 23B by 90° in a left direction in addition to the image data 23A. If the user presses an “OK” button, the image control unit 213 generates pieces of image data 23A and 23B as rotated by 90° in the left direction and stores the pieces of image data 23A and 23B in the RAM 105.

As described above, the image control unit 213 performs rotation control of the image data 23B (forming a pair in addition to the image data 23A), in response to the rotation instruction on the image data 23A. Thus, if scanning is performed on both sides of an original document, and then the multi-cropping process is performed, it is possible to perform rotation control of pieces of image data of the front surface and the back surface of a document since the pieces have been established as related to each other, in accordance with a simple operation. That is, the image control unit 213 can rotate image data for both sides of the same original document by any degree in any direction, in accordance with a simple operation.

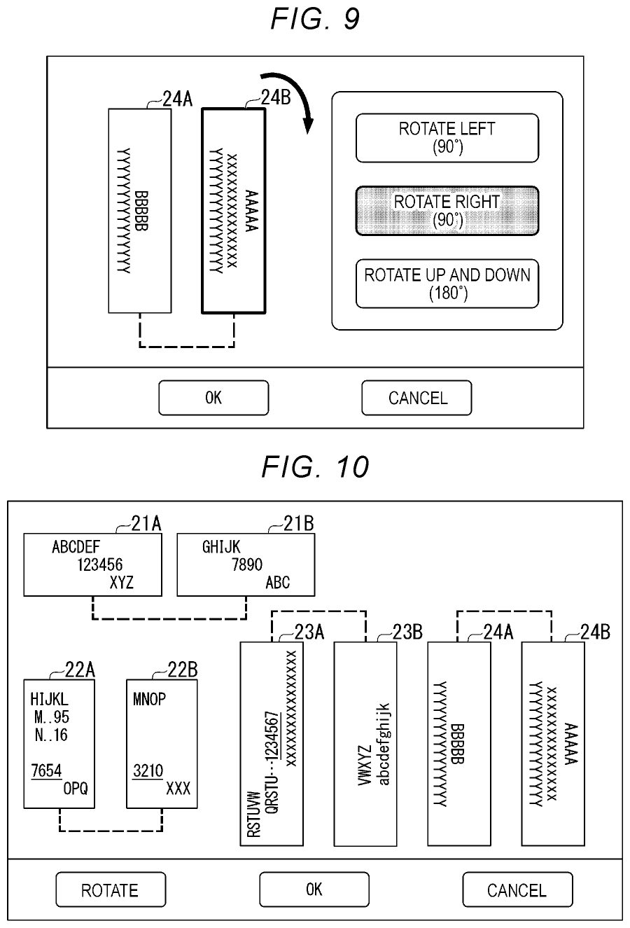

FIG. 9 is a diagram illustrating a second example of the rotation control screen displayed at the control panel. FIG. 9 illustrates a case where the user selects the image data 24B, as an example. If the image control unit 213 detects the pressing of the “rotate” instruction button, the image control unit 213 displays the rotation control screen illustrated in FIG. 9.

The image control unit 213 displays the image data 24A (forming a pair with the image data 24B) in a preview manner, in addition to the selected image data 24B. In the example in FIG. 9, a case where the user presses the button for instructing “rotate right (90°)” is described as an example. In response to the detection of button pressing, as illustrated in FIG. 9, the image control unit 213 displays an image obtained by rotating the direction of the image data 24A by 90° in a right direction in addition to the image data 24B, in a preview manner. If the user presses an “OK” button, the image control unit 213 generates pieces of image data 24A and 24B rotated by 90° in the right direction and stores the pieces of image data 24A and 24B in the RAM 105.

As described above, the image control unit 213 performs rotation control of the image data 24A (forming a pair in addition to the image data 24B), in response to the rotation instruction on the image data 24B. Thus, when scanning is performed on both sides of an original document, and then the multi-cropping process is performed, it is possible to perform rotation control of pieces of image data for the front surface and the back surface of the same document in accordance with a simple operation. That is, the image control unit 213 can rotate image data for both sides of the same original document by any degree in any direction, in accordance with a simple operation.

FIG. 10 is a diagram illustrating a second example of the preview screen of image data displayed at the control panel. FIG. 10 illustrates the preview screen of the image data after the rotation control described with reference to FIGS. 8 and 9 has been performed. FIG. 10 illustrates that the rotation control has been performed on the pieces of the image data 23A and 23B and the pieces of the image data 24A and 24B from the example in FIG. 7.

### Modification Example

If the directions of images in an image data pair are different from each other, the linking unit 212 may cancel the association of the image data in response to the designation on, for example, the operation unit 109 and permit pieces of image data to be individually rotated. The image control unit 213 receives a cancellation instruction designating an image data pair as a target for canceling the present association through the operation unit 109. The image control unit 213 then cancels the association of the image data pair designated in accordance with the cancellation instruction. In this case, the image control unit 213 may individually rotate and control each piece of image data of the now canceled pairing after the association is canceled. The linking unit 212 may perform an association again after the individual rotation process and re-designate or associate the image data as an image data pair. Thus, it is possible to relate and rotate an image data pair so that the directions coincide with each other.

Even if the directions in the image data pair are different from each other, the image control unit 213 may still rotate the image data pair together. Accordingly, the user can acquire image data having a desired direction.

As described above, the image reading device of an example includes the reading unit 101 and the control unit (e.g., processor 104 executing image control program 110). The reading unit 101 reads front surfaces and back surfaces of a plurality of original documents placed together on the original document table and generates image data for each document surface. The control unit generates original document image data obtained by cutting a region of each original document out from the image data for each side. The control unit associates original document image data of the front surface and original document image data of the back surface of the same original document to each other, as an original document image data pair. Further, the control unit processes and rotates the original document image data pair in accordance with a rotation instruction, and outputs the rotated original document image data pair.

If a multi-cropping process is performed for both sides of an original document, then the number of pieces of generated image data increases. Thus, the association between pieces of image data of the front surface and the back surface and a process of adjusting the direction of the image data are extended, and the operation becomes more complicated. The direction of the image data may be automatically changed, for example, to the direction in which the character string is easily read, in accordance with the content of an original document image. However, the direction of the image data may be intended to be set to a direction different from the direction in which the character string is easily read. In such a case, in order to change the direction, it is necessary to detect pieces of image data of the front surface and the back surface of the same original document, and to individually change the direction of each piece of detected image data. Such a process takes labor and is complicated.

In the present embodiment, the image reading device may detect an image data pair consisting of both sides of an original document, and process and rotate the image data pair in accordance with any rotation direction and any rotation degree. Thus, it is possible to efficiently change the orientation of pieces of image data of the front surface and the back surface of each original document in accordance with a simple operation. Accordingly, the complexity of the process of adjusting the direction of each piece of image data when the multi-cropping process is performed on both sides of an original document is reduced.

In the present embodiment, the image reading device further includes the operation unit 109 that receives the rotation instruction for designating original document image data as the rotation target. The control unit and rotates first original document image data and second original document image data together when the first original document image data and the second original document data form a pair (e.g., a front and back side of the same original document), in accordance with the rotation instruction on the first original document image data input through the operation unit 109.

As described, the user can perform the rotation control on image data of both sides at the same time simply by designating the rotation instruction for one of the pieces of image data for the front surface or the back surface. Thus, it is possible to omit an operation of the rotation control on image data of the other side, and thus the operation complexity is reduced. That is, it is possible to efficiently process and adjust the direction of pieces of image data of the front surface and the back surface of each original document in accordance with a simple operation.

The control unit processes and rotates an original document image data pair subjected to the rotation control, for example, during a text skew correction processing for the images of each original document, in accordance with the rotation instruction. Thus, even if the rotation control is automatically performed on the image of each original document, it is possible to simply set the direction of the image data pair to any direction in a unit of the image data pair.

The control unit can cancel the association of an original document image data pair as designated through the operation unit. Thus, it is possible to individually perform the rotation control on pieces of image data after an association with another image has been canceled. In addition, it is possible to process and rotate the image data pair after the direction is individually adjusted.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image reading device, comprising:
a scanner configured to read multiple documents on a document platen and generate image data; and
a controller configured to:
generate document image data by cropping a region corresponding to each document on the document platen from the generated image data and, when multi-sided scanning is selected, associate generated document image data for a front surface of each document with generated document image data for a back surface of the same document to establish a document image data pair for each document on the document platen;
receive a rotation instruction for one piece of document image data in a document image pair and then rotate both pieces of document image data in the document image pair together; and
output the rotated document image data pair.

2. The image reading device according to claim 1, further comprising:
an input operation unit configured to receive the rotation instruction from a user to designate the one piece of document image data as a rotation target.

3. The image reading device according to claim 2, wherein the input operation unit comprises a touch panel display.

4. The image reading device according to claim 2, wherein the controller is configured to generate a preview image of a first piece of document image data in a pair and a preview image of a second piece of document image data in the pair and display the generated preview images on a display screen.

5. The image reading device according to claim 4, wherein the preview images are rotated at the same time in response to a user instruction to rotate at least one of the preview images received via the input operation unit.

6. The image reading device according to claim 2, wherein the controller is configured to generate preview images for the front and back surfaces of each document in the multi-sided scanning and then display the preview images for the front and back surfaces of each document on a display screen together at the same time.

7. The image reading device according to claim 1, wherein the output of the rotated document image data pair comprises storing the rotated document image data of the pair together as a single document file in a storage device.

8. The image reading device according to claim 1, wherein the output of the rotated document image data pair comprises printing the rotated document image data pair together on a single sheet.

9. The image reading device according to claim 8, wherein the document image data for the front surface of the document in the rotated document image data pair is printed on one side of the single sheet and the document image data for the back surface of the document in the rotated document image data pair is printed on the other side of the single sheet.

10. The image reading device according to claim 1, wherein an orientation for the generated document image data is set according to an optical character recognition processing performed on the document image data to establish a text orientation of text on the document.

11. The image reading device according to claim 1, wherein the controller is configured to cancel the association between generate document image data for a front surface of a document and generated document image data for a back surface of a document in a previously established document image data pair upon receiving a user instruction via an input operation unit to cancel the association.

12. A scanner unit, comprising:
a document platen on which documents can be placed;
an input operation unit including a display screen;
a scanner configured to scan multiple documents placed on the document platen and generate image data; and
a processor configured to:
generate document image data by cropping a region corresponding to each document on the document platen from the image data of the scanner and, when a multi-sided scanning mode is selected, associate generated document image data for a front surface of each document with generated document image data for a back surface of the same document to establish a document image data pair for each document on the document platen;
generate preview images of a first piece of document image data in each established pair and preview images of a second piece of document image data in each established pair and display the generated preview images on the display screen;
receive a rotation instruction via the input operation unit for one piece of document image data in a document image pair and rotate both pieces of document image data in the document image pair together; and
output the rotated document image data pair.

13. The scanner unit according to claim 12, wherein the preview images are rotated at the same time in response to a user instruction to rotate at least one of the preview images received via the input operation unit.

14. The scanner unit according to claim 12, wherein the input operation unit comprises a touch screen.

15. The scanner unit according to claim 12, wherein the preview image for the first piece of document image data in each established pair is displayed adjacent to the preview image for the second piece of document image data in the respective established pair.

16. An image reading method comprising:
scanning first surfaces of a plurality of documents placed on a document platen and generating first image data including image data for each document;
scanning second surface of the plurality of documents and generating second image data including image data for each document;
generating first side document image data by cropping a region corresponding to each document from the generated first image data;
generating second side document image data by cropping the region corresponding to each document from the generated second image data;
associating first side document image data with second side document image data to establish document image pairs corresponding to each document in the plurality of documents;
receiving a rotation instruction for one piece of document image data in an established document image pair and the rotate both pieces of document image data in the established document image pair together; and
outputting the rotated established document image pair.

17. The image reading method according to claim 16, further comprising:
generating a preview image of a first piece of document image data in an established document image pair and a preview image of a second piece of document image data in the established document image pair and then displaying the generated preview images on a display screen.

18. The image reading method according to claim 17, wherein the rotation instruction is received from a user via input operation unit including the display screen displaying the generated preview images.

19. The image reading method according to claim 16, wherein outputting of the rotated established document image pair comprises storing the first and second pieces of document image data in the rotated established document image pair together as a single document file in a storage device.

20. The image reading method according to claim 16, wherein outputting the rotated established document image pair comprises printing the first and second pieces of document image data in the rotated established document image pair together on a single sheet.
